(19) United States
(12) Patent Application Publication
(10) Pub. No.: US 2021/0158371 A1
(43) Pub. Date: May 27, 2021

(54) VERIFIED VIDEO REVIEWS

(71) Applicant: eBay Inc., San Jose, CA (US)

(72) Inventors: Rutvij Sudhir Dhotey, Sunnyvale, CA (US); Ravneet Kaur, Sunnyvale, CA (US); Charles Douglas Watkins, San Jose, CA (US); Olivia Shing-Ron Yu, Cupertino, CA (US); Gnanasekar Palaniappan, Cupertino, CA (US); Umme Habiba Shaik, San Jose, CA (US)

(21) Appl. No.: 16/690,884

(22) Filed: Nov. 21, 2019

(51) Int. Cl. G06Q 30/00; G06Q 30/02; G06Q 30/06

(52) U.S. Cl. CPC G06Q 30/018; G06Q 30/0643; G06Q 30/0214

(57) ABSTRACT

A machine is configured to generating an enhanced user interface for displaying a feed of video reviews that includes verified video reviews. For example, the machine receives, from a client device associated with a user, a request to publish a video review of an item. The request includes a description of the item, including an identifier of the item. The machine accesses a user account associated with the user, and verifies that the user previously purchased the item. The machine causes, based on the verifying that the user previously purchased the item, online publishing of the video review as a verified video review of the item in a feed of video reviews. The feed of video reviews includes one or more verified video reviews. Each of the video reviews is associated with a link to facilitate purchasing the item being reviewed in a particular video review.

### TECHNICAL FIELD

Embodiments of the present disclosure relate generally to providing verified video reviews, but not by way of limitation, to generating an enhanced user interface for displaying a feed of video reviews that includes verified video reviews.

### BACKGROUND

Generally, web sites that publish digital content pertaining to items of interest to the public present such digital content as listings that include various information about the items. An example of such digital content is a listing published on behalf of a seller of a product. A user interface of a client device presents listings of products that may include one or more photographs of the product and a description of one or more attributes of the product.

Certain online platforms allow users to post reviews for various products. The review may receive one or more types of social signals (e.g., likes or shares) indicating viewers opinion with respect to the review. Unfortunately, some reviews are dishonest, and can cause the reader of a review to be disappointed using a product purchased based on a dishonest review.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 illustrates a user interface displaying a feed of video reviews, according to some example embodiments.

FIG. 3 illustrates a user interface displaying a video review, according to some example embodiments.

FIG. 4 is a block diagram illustrating components of a video review system, according to some example embodiments.

FIG. 5 is a flow diagram illustrating a method for publishing a verified video review, according to some example embodiments.

FIG. 6 is a flow diagram illustrating a method for publishing a verified video review, and representing step 504 of the method illustrated in FIG. 5 in more detail, according to some example embodiments.

FIG. 7 is a block diagram illustrating an example of a software architecture that may be installed on a machine, according to some example embodiments,

FIG. 8 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

According to some example embodiments, a video review system receives, from a client device associated with a user, a request to publish (hereinafter also “post”) a video review of an item on an electronic marketplace. The request may be received via an application (hereinafter also “app”) installed on the client device. The application may provide a user interface that is displayed on the client device, and via which a request to post a video review may be made by the user. The request may include a description of the item, and the description of the item may include an identifier of the item.

The video review system, based on the received request, accesses a user account associated with the user. The user account includes various types of data (e.g., profile data, transaction data, etc.) associated with the user. The video review system verifies that the user previously purchased the item by determining that the identifier of the item is associated with the user account. For example, the video review system determines that the identifier of the item is included in transaction data included in the user account,

Based on verifying that the user previously purchased the item, the video review system allows the user to post a video review of the item on the electronic marketplace via the app. For example, the video review system causes, based on the verifying that the user previously purchased the item, online publishing of the video review as a verified video review of the item in a feed of video reviews. The feed of video reviews includes one or more verified video reviews. Each of the video reviews is associated with a link to facilitate purchasing the item being reviewed in a particular video review.

The causing of online publishing of the video review as a verified video review includes enhancing the user interface of the client device to display the feed of video reviews that includes verified video reviews, A verified video review may be associated with one or more user interface elements (e.g., a mark, a tag, an indicator, etc.) that indicate that the video review is verified. In some example embodiments, a selection to view a particular video review is logged by the video review system, and may serve as basis for a reward for the user who posted the verified video review. In various example embodiments, a purchase of the item by a second user based on viewing the video review posted by a first user serves as basis for a reward for the first user. An example of a reward may be a number of points that can be converted to a gift certificate for the user who posted the verified video review.

Conventional user interfaces have many deficits relating to the efficient functioning of the computer, requiring a user of a conventional user interface to scroll around and switch views many times to find the right data associated with an item, especially when the conventional user interface is displayed on a small screen. Because small screens tend to need data and functionality divided into many layers or views, conventional user interfaces require users to drill down through many layers to get to desired data or functionality. That process could seem slow, complex, and difficult to learn, particularly to novice users. Further, that process decreases data processing speeds, and is often associated with higher data storage requirements.

In some example embodiments, a video review system that provides a feed of video reviews displayed via a user interface improves conventional user interfaces by presenting the verified reviews in the video format as opposed to other formats (e.g., text) that may use more space in the user interface. The presentation of the review information pertaining to the item in the video format also enhances the efficiency of the electronic devices by improving data processing speeds and data storage efficiency.

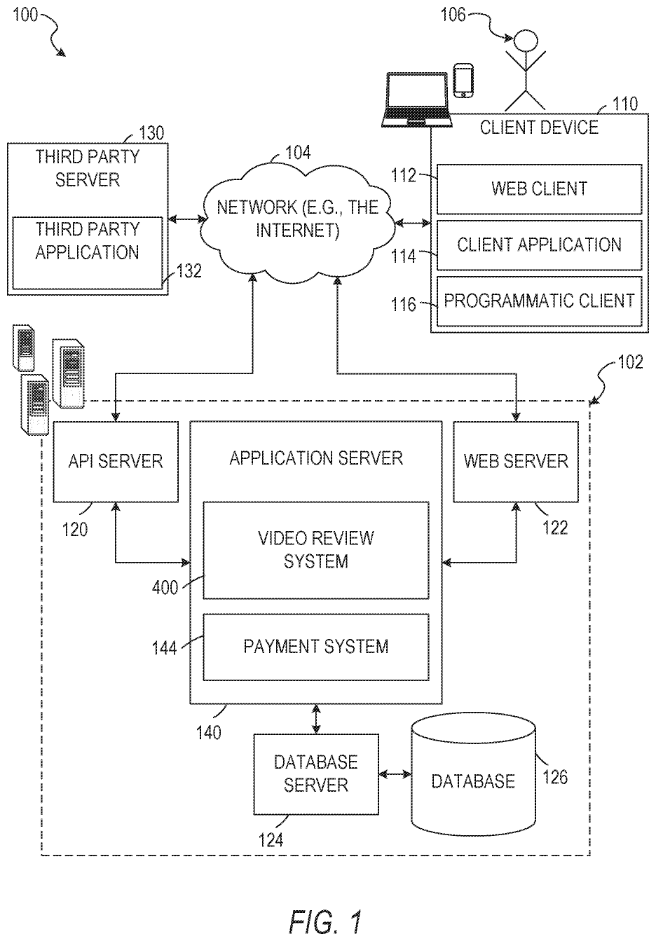

With reference to FIG. 1, an example embodiment of a high-level client-server-based network architecture 100 is shown. A networked system 102 provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Washington State), a client application 114, and a programmatic client 116 executing on client device 110.

The client device 110 may comprise, but is not limited to, mobile phones, desktop computers, laptops, portable digital assistants (PDAs), smart phones, tablets, ultra books, netbooks, multi-processor systems, microprocessor-based or programmable consumer electronics, game consoles, set-top boxes, wearable devices, smart watches, or any other communication devices that a user may utilize to access the networked system 102. In some embodiments, the client device 110 may comprise a display module to display information (e.g., in the form of user interfaces). In further embodiments, the client device 110 comprises one or more of a touch screens, accelerometers, gyroscopes, cameras, microphones, global positioning system (GPS) devices, and so forth. The client device 110 is a device of a user that can be used to perform a transaction involving digital items within the networked system 102. In some example embodiments, the networked system 102 comprises a network-based marketplace (also referred to as “online marketplace”) that responds to requests for product listings, publishes publications comprising item listings of products or services available on the network-based marketplace, and manages payments for these marketplace transactions. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in the client device 110, then this application is configured to locally provide the user interface and at least some of the functionalities with the application configured to communicate with the networked system 102, on an as needed basis, for data or processing capabilities not locally available (e.g., to access to a database of items available for sale, to authenticate a user, to verify a method of payment, etc.). Conversely, if the e-commerce site application is not included in the client device 110, the client device 110 uses its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 may host a video review system 400 and a payment system 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or databases 126. In an example embodiment, the databases 126 are storage devices that store information (e.g., publications, listings, digital content items, product descriptions, images of products, etc.) to be utilized by the video review system 400. The databases 126 may also store digital item information, in accordance with example embodiments.

Additionally, a third party application 132, executing on one or more third party servers 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The video review system 400 provides a number of publication functions and services to users 106 that access the networked system 102. For example, the video review system 400 facilitates the generation and online publishing of a customized banner image for a particular user based on one or more data features associated with the particular user. The one or more data features include a data feature pertaining to user behavior in relation to an image of a product. The payment system 144 provides a number of functions to perform or facilitate payments and transactions. While the video review system 400 and payment system 144 are shown in FIG. 1 to both form part of the networked system 102, it will be appreciated that, in alternative embodiments, each of the video review system 400 and payment system 144 may form part of a service that is separate and distinct from the networked system 102 In some embodiments, the payment system 144 may form part of the video review system 400.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The video review system 400 and payment system 144 could also be implemented as standalone software programs, which do not necessarily have networking capabilities.

The web client 112 accesses the video review system 400 or the payment system 144 via the web interface supported by the web server 122. Similarly, the programmatic client 116 accesses the various services and functions provided by the video review system 400 or the payment system 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

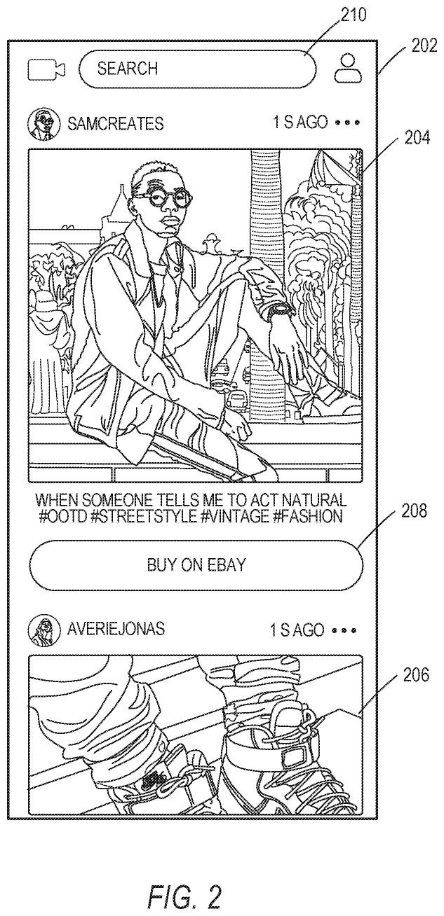

FIG. 2 illustrates a user interface displaying a feed of video reviews, according to some example embodiments. As shown in FIG. 2, user interface 202 displays a feed of video reviews including video review 204 and video review 206.

in some example embodiments, a user searches for items or for item reviews using the search user interface element 210. The video review system 400 receives search terms (e.g., one or more hashtags) via the search user interface element 210 of a client device, and identifies one or more video reviews that match the search terms. In some example embodiments, a user provides audio search terms (e.g., by using the user's voice, by providing an audio input that includes search terms, etc.). The video review system 400 can extract sound from the video reviews, and match the voice search terms input and terms identified based on the sound extracted from the video reviews to generate search results (e.g., identified video reviews).

The video review system 400 then causes display of the identified one or more video reviews (e.g., video review 204 and video review 206) in the user interface 202. In some example embodiments, a video review that has been determined to be verified, by the video review system 400, may be marked with an indicator (e.g., a tag, a mark, a note, etc.) that communicates that the reviewer previously purchased the item reviewed in the verified video review.

A selection, by the user, of a displayed video review causes the generation of a request to play the selected video review. The video review system 400 plays the selected video review in the user interface 202 based on the request to play the selected video review.

A video review may be associated with a link to facilitate the purchasing of one or more items shown in the video review. As shown in FIG. 2, an example of such a link is the user interface element 208. In some example embodiments, user interface element 208 is associated with a message that communicates to the user where the user can purchase one or more items shown in the video review (e.g., “Buy on eBay.”). A selection, by the user, of user interface element 208 causes display of one or more listings associated with the items illustrated in the video reviews. The one or more listings may be offering for sale the actual items shown in a particular video review (e.g., the actual jacket worn by the person shown in video review 204), or items of the type of items shown in the particular video review (e.g., a jacket that is the same brand or type, or looks like the jacket worn by the person shown in video review 204).

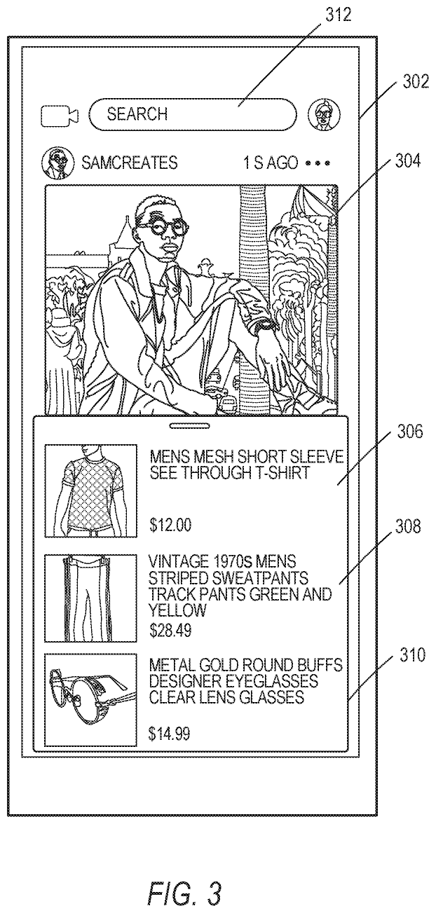

FIG. 3 illustrates a user interface displaying a video review, according to some example embodiments. As shown in FIG. 3, when a user selects a video review (e.g., video review 304), the video review system 400 causes the selected video review to play. Also, the video review system 400 causes one or more listings (e.g., listings 306, 308, and 310) associated with items that appear in the video review to be displayed in user interface 302,

Also, the video review system 400 may cause other user interface elements to be displayed in the user 302. For example, as shown in FIG. 3, the video review system 400 causes display of a search user interface element 312 to facilitate a search for video reviews via the user interface 302.

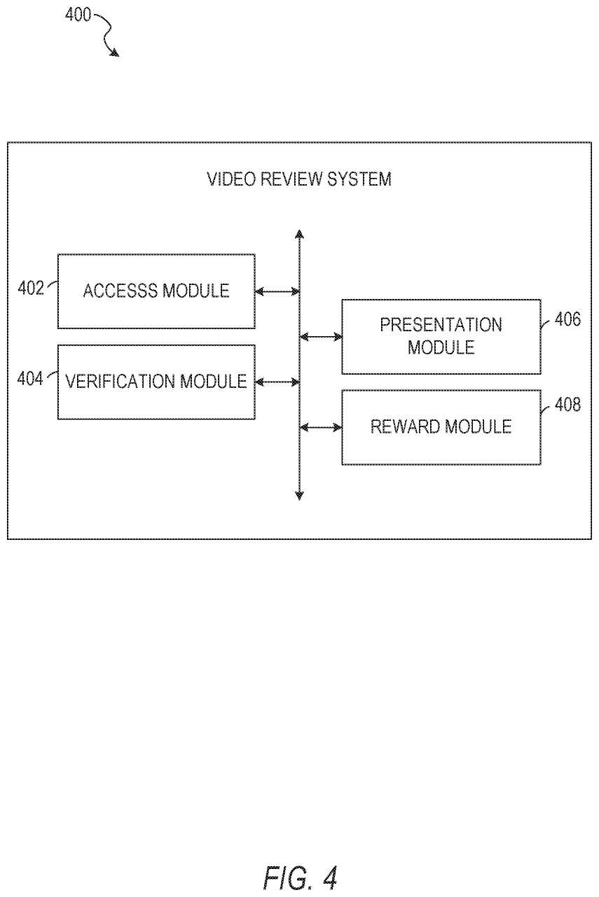

FIG. 4 is a block diagram illustrating components of the video review system 400, according to some example embodiments. As shown in FIG. 4, the video review system 400 includes an access module 402, a verification module 404, a presentation module 406, and a reward module 408, all configured to communicate with each other (e.g., via a bus, shared memory, or a switch)

According to some example embodiments, the access module 402 receives, from a client device associated with a user, a request to publish a video review of an item. The video review includes a video that displays the item. The item is being reviewed in the video review. The user may or may not appear in the video review. The request to publish the video review includes a description of the item. The description may include a video or an image of the item, an audio description of the item, or a text description of the item. The description of the item includes an identifier (e.g., a name) of the item.

The access module 402 also accesses a user account associated with the user. The user account associated with the user may include various data pertaining to the user (e.g., transaction data of prior purchases by the user, profile data, preference data, payment data, etc.).

The verification module 404 verifies that the user previously purchased the item. The verifying that the user previously purchased the item includes determining that the identifier of the item is associated with the user account.

The presentation module 406 causing online publishing of the video review as a verified video review of the item in a feed of video reviews. The causing of the online publishing of the video review as a verified video is based on the verifying that the user previously purchased the item. The feed of video reviews includes one or more verified video reviews. Each of the video reviews is associated with a link to facilitate purchasing the item being reviewed in a particular video review.

For example, the video review system 400 receives, from a client device associated with a user with the user identifier “User1234,” a request to publish a video review of a Kate Spade bag. The video review system 400 accesses an account associated with the user (e.g., the purchase record of User1234) using the user identifier “User1234.” The video review system 400 determines that the purchase record associated with User1234 includes an identifier of the Kate Spade bag. Based on this determination, the system allows the posting of a “verified” video review, by User1234, of the Kate Spade bag. A link to facilitate purchasing the Kate Spade bag (e.g., the same bag that is being reviewed by User1234, or another bag of the same type) is provided in association with the verified video review for another user to purchase the Kate Spade bag.

The reward module 408 provides a reward to the user based on the causing of the online publishing of the video review as a verified video review based on the verifying that the user previously purchased the item. The reward module 408 also provides a reward to the user based on determining that another user purchased the item based on selecting the link associated with the video review. In some example embodiments, the providing of the reward includes generating a database record that indicates that the user is assigned a certain value (e.g., points, cash, etc.) as a reward for certain actions by the user or by other users with respect to a video review. In some example embodiments, the providing of the reward includes causing display in the user interface of a client device of information pertaining to the reward provided to the reviewer of the item.

To perform one or more of its functionalities, the video review system 400 communicates with one or more other systems. For example, an integration engine (not shown) may integrate the video review system 400 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources to allow information to be passed between the applications and to allow the applications to share and access common data. Furthermore, the modules may access one or more of the databases 226.

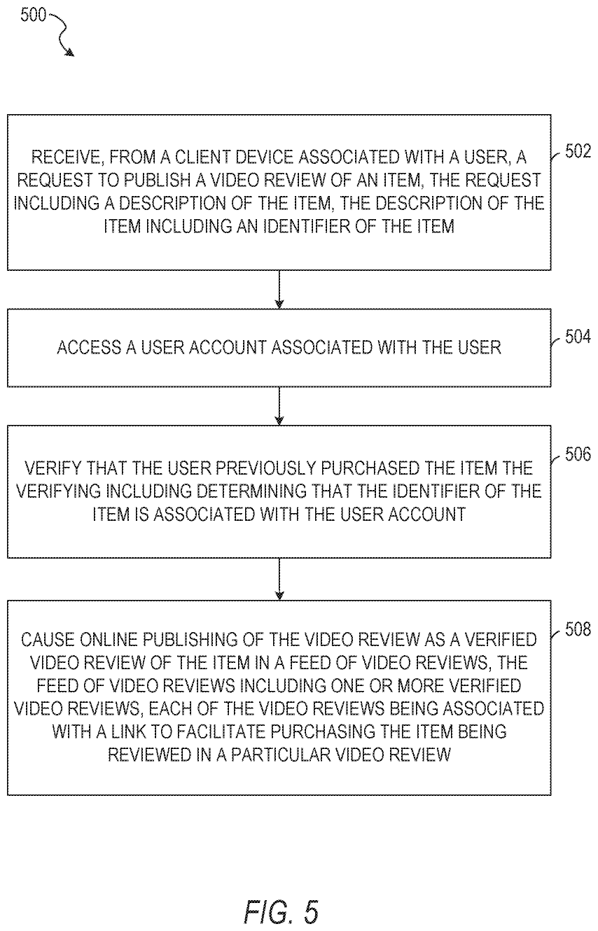

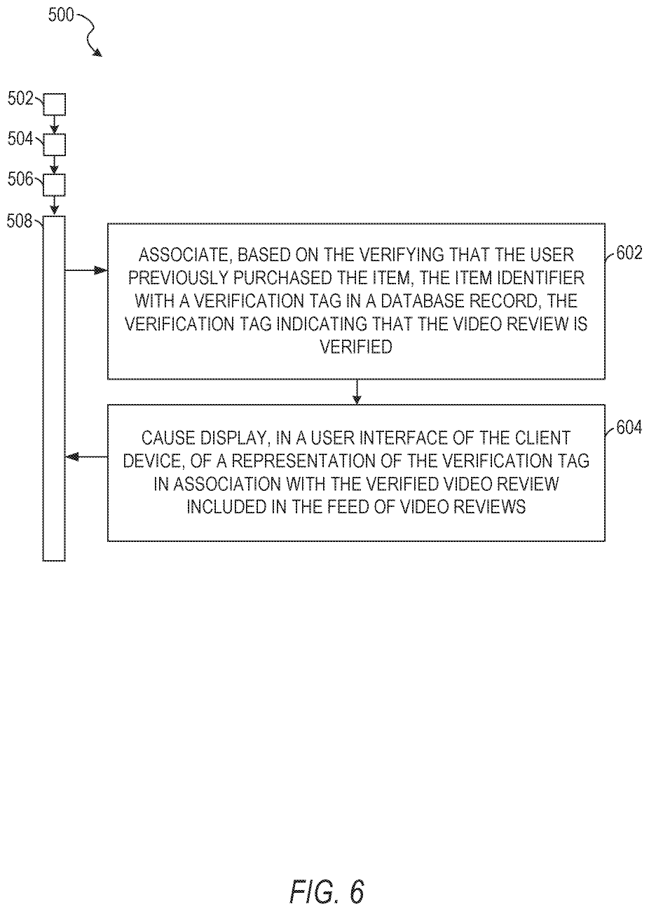

FIGS. 5 and 6 are flowcharts illustrating a method for publishing a verified video review, according to some example embodiments. Operations in method 50( )illustrated in FIG. 5 may be performed using modules described above with respect to FIG. 4. As shown in FIG. 5, method 500 may include one or more of method operations 502, 504, 506, and 508, according to example embodiments.

At operation 502, the access module 402 receives, from a client device associated with a user, a request to publish a video review of an item. The request includes a description of the item. The description of the item includes an identifier of the item.

At operation 504, the access module 402 accesses a user account associated with the user.

At operation 506, the verification module 404 verifies that the user previously purchased the item. The verifying includes determining that the identifier of the item is associated with the user account.

At operation 508, the presentation module 406 causes online publishing of the video review as a verified video review of the item in a feed of video reviews. The causing of the online publishing of the video review as a verified video review is based on the verifying that the user previously purchased the item. The feed of video reviews includes one or more verified video reviews. Each of the video reviews is associated with a link to facilitate purchasing the item being reviewed in a particular video review. In some example embodiments, the verified video review includes a video illustrating the item previously purchased by the user. In some example embodiments, the verified video review provides the link to facilitate purchasing the item.

In various example embodiments, the causing of the online publishing of the video review as a verified video review of the item includes causing display of the verified video review in a user interface of the client device.

In some example embodiments, the reward module 408 provides a reward to the user based on the causing of the online publishing of the video review as a verified video review based on the verifying that the user previously purchased the item. In certain example embodiments, the reward module 408 provides a reward to the user based on determining that another user purchased the item based on selecting the link associated with the video review.

In certain example embodiments, the access module 402 receives, from a further client device, a request to view video reviews associated with the item. In response to the request received from the further client device, the presentation module 406 causes display of the verified video review in a user interface of the further client device.

Further details with respect to the method operations of method 500 are described below with respect to FIG. 6.

As shown in FIG. 6, method 500 includes one or more of operations 602 and 604, according to some embodiments. Operation 602 may be performed as part (e.g., a precursor task, a subroutine, or a portion) of operation 508, in which the presentation module 406 causes online publishing of the video review as a verified video review of the item in a teed of video reviews.

At operation 602, the presentation module 406 associates, based on the verifying that the user previously purchased the item, the item identifier with a verification tag in a database record, the verification tag indicating that the video review is verified.

At operation 604, the presentation module 406 causes display, in a user interface of the client device, of a representation of the verification tag in association with the verified video review included in the feed of video reviews.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled, A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

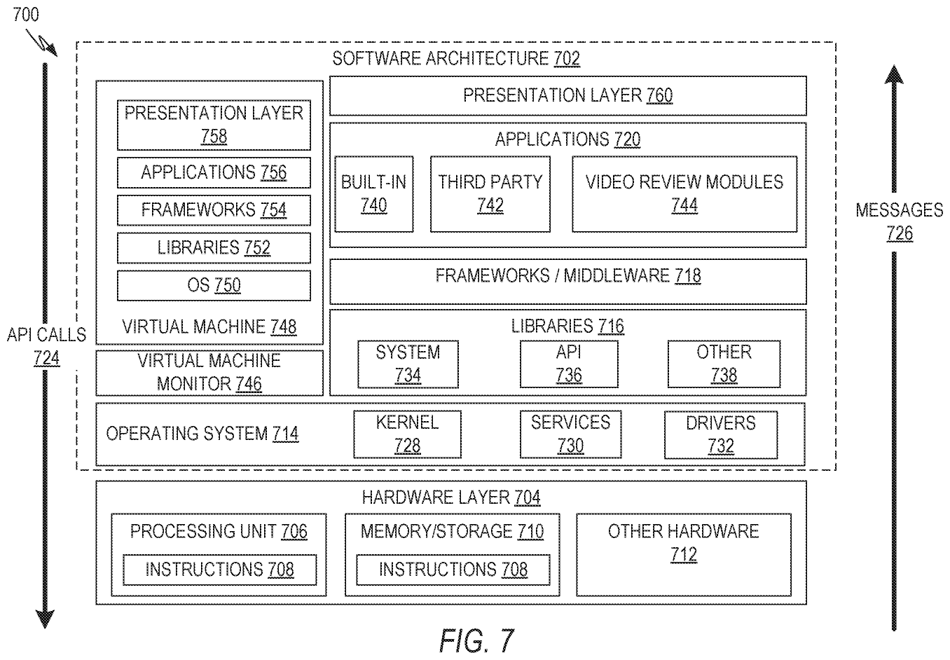

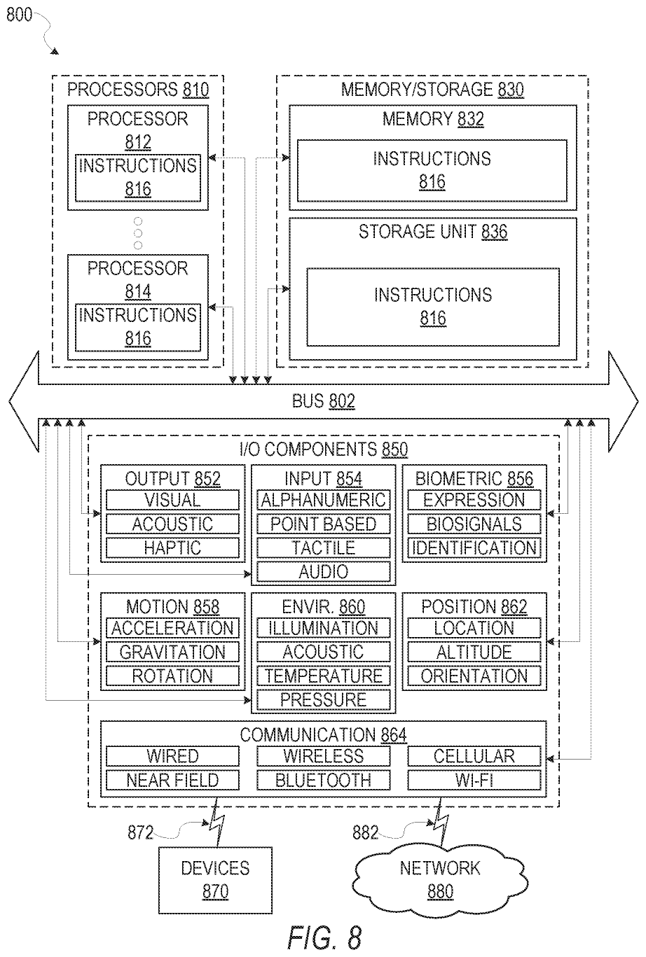

The modules, methods, applications and so forth described in conjunction with FIGS. 7 and 8 are implemented in some embodiments in the context of a machine and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” While yet another combination produces a server computer for use within a cloud computing architecture. Not all combinations of such software and hardware architectures are presented here as those of skill in the art can readily understand how to implement the invention in different contexts from the disclosure contained herein,

FIG. 7 is a block diagram 700 illustrating a representative software architecture 702, which may be used in conjunction with various hardware architectures herein described. FIG. 7 is merely a non-limiting example of a software architecture and it will be appreciated that many other architectures may be implemented to facilitate the functionality described herein, The software architecture 702 may be executing on hardware such as machine 800 of FIG. 8 that includes, among other things, processors 810, memory 830, and I/O components 850. A representative hardware layer 704 is illustrated and can represent, for example, the machine 800 of FIG. 8. The representative hardware layer 704 comprises one or more processing units 706 having associated executable instructions 708. Executable instructions 708 represent the executable instructions of the software architecture 702, including implementation of the methods, modules and so forth of FIGS. 1-6. Hardware layer 704 also includes memory and/or storage modules 710, which also have executable instructions 708. Hardware layer 704 may also comprise other hardware as indicated by 712 which represents any other hardware of the hardware layer 704, such as the other hardware illustrated as part of machine 800.

In the example architecture of FIG. 7, the software 702 may be conceptualized as a stack of layers where each layer provides particular functionality. For example, the software 702 may include layers such as an operating system 714, libraries 716, frameworks/middleware 718, applications 720 and presentation layer 760. Operationally, the applications 720 and/or other components within the layers may invoke application programming interface (API) calls 724 through the software stack and receive a response, returned values, and so forth illustrated as messages 726 in response to the API calls 724. The layers illustrated are representative in nature, and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display) database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 and/or other software components/modules. For example, the frameworks 718 may provide various graphic user interface (GUI) functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740, third party applications 742, and video review modules 744 (e.g., access module 402, presentation module 404, verification module 406, or reward module 408). Examples of representative built-in applications 740 may include, but are not limited to, a contacts application, a browser application, a book reader application, a location application, a media application, a messaging application, and/or a game application. Third party applications 742 may include any of the built in applications as well as a broad assortment of other applications. In a specific example, the third party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 742 may invoke the API calls 724 provided by the mobile operating system such as operating system 714 to facilitate functionality described herein.

The applications 720 may utilize built in operating system functions (e.g., kernel 728, services 730 and/or drivers 732), libraries (e.g., system 734, APIs 736, and other libraries 738), frameworks/middleware 718 to create user interfaces to interact with users of the system. Alternatively, or additionally, in some systems interactions with a user may occur through a presentation layer, such as presentation layer 760. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware machine (such as the machine of FIG. 8, for example). A virtual machine is hosted by a host operating system (operating system 714 in NG. 8) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 and/or presentation layer 760. These layers of software architecture executing within the virtual machine 748 can be the same as corresponding layers previously described or may be different.

FIG. 8 is a block diagram illustrating components of a machine 800, according to some example embodiments, able to read instructions from a machine-readable medium (e.g., a machine-readable storage medium) and perform any one or more of the methodologies discussed herein, Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions may cause the machine to execute the flow diagrams of FIGS. 5 and 6. Additionally, or alternatively, the instructions may implement the access module 402, the verification module 404, the presentation module 406, and the reward module 408 of FIG. 4. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing ((CSC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as, location via Internet Protocol (IP) geo-location, location via Wi-Fi® signal triangulation, location via detecting an NFC beacon signal that may indicate a particular location, and so forth.

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

### Executable Instructions and Machine-Storage Medium

The various memories (i.e., 830, 832, and/or memory of the processor(s) 810) and/or storage unit 836 may store one or more sets of instructions and data structures (e.g., software) 816 embodying or utilized by any one or more of the methodologies or functions described herein. These instructions, when executed by processor(s) 810 cause various operations to implement the disclosed embodiments,

As used herein, the terms “machine-storage medium,” “device-storage medium,” “computer-storage medium” (referred to collectively as “machine-storage medium”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method comprising:
receiving, from a client device associated with a user, a request to publish a video review of an item, the request including a description of the item, the description of the item including an identifier of the item;
accessing a user account associated with the user;
verifying, using one or more hardware processors, that the user previously purchased the item, the verifying including determining that the identifier of the item is associated with the user account; and
causing, based on the verifying that the user previously purchased the item, online publishing of the video review as a verified video review of the item in a feed of video reviews, the feed of video reviews including one or more verified video reviews, each of the video reviews being associated with a link to facilitate purchasing the item being reviewed in a particular video review.

2. The method of claim 1, further comprising:
providing a reward to the user based on the causing of the online publishing o the video review as a verified video review based on the verifying that the user previously purchased the item.

3. The method of claim 1, further comprising:
providing a reward to the user based on determining that another user purchased the item based on selecting the link associated with the video review.

4. The method of claim 1, wherein the causing of the online publishing of the video review as a verified video review of the item includes:
causing display of the verified video review in a user interface of the client device.

5. The method of claim 1, further comprising:
receiving, from a further client device, a request o view video reviews associated with the item; and
causing display of the verified video review in a user interface of the further client device.

6. The method of claim 1, wherein the verified video review provides the link to facilitate purchasing the item.

7. The method of claim 1, wherein the verified video review includes a video illustrating the item previously purchased by the user.

8. The method of claim 1, wherein the causing online publication of the video review as a verified video review of the item in the feed of video reviews includes:
associating, based on the verifying that the user previously purchased the item, the item identifier with a verification tag in a database record, the verification tag indicating that the video review is verified; and
causing display, in a user interface of the client device, of a representation of the verification tag in association with the verified video review included in the feed of video reviews.

9. A system comprising:
one or more hardware processors; and
a machine-readable medium for storing instructions that, when executed by the one or more hardware processors, cause the one or more hardware processors to perform operations comprising:
receiving, from a client device associated with a user, a request to publish a video review of an item, the request including a description of the item, the description of the item including an identifier of the item;
accessing a user account associated with the user;
verifying that the user previously purchased the item, the verifying including determining that the identifier of the item is associated with the user account; and
causing, based on the verifying that the user previously purchased the item, online publishing of the video review as a verified video review of the item in a feed of video reviews, the feed of video reviews including one or more verified video reviews, each of the video reviews being associated with a link to facilitate purchasing the item being reviewed in a particular video review.

10. The system of claim 9, further comprising:
providing a reward to the user based on the causing of the online publishing of the video review as a verified video review based on the verifying that the user previously purchased the item.

11. The system of claim 9, further comprising:
providing a reward to the user based on determining that another user purchased the item based on selecting the link associated with the video review.

12. The system of claim 9, wherein the causing of the online publishing of the video review as a verified video review of the item includes:
causing display of the verified video review in a user interface of the client device.

13. The system of claim 9, further comprising:
receiving, from a further client device, a request o view video reviews associated with the item; and
causing display of the verified video review in a user interface of the further client device.

14. The system of claim 9, wherein the verified video review provides the link to facilitate purchasing the item.

15. The system of claim 9, wherein the verified video review includes a video illustrating the item previously purchased by the user.

16. The system of claim 9, wherein the causing online publication of the video review as a verified video review of the item in the feed of video reviews includes:
associating, based on the verifying that the user previously purchased the item, the item identifier with a verification tag in a database record, the verification tag indicating that the video review is verified; and
causing display, in a user interface of the client device, of a representation of the verification tag in association with the verified video review included in the feed of video reviews.

17. A non-transitory machine-readable medium comprising instructions, which when executed by one or more hardware processors, cause the one or more hardware processors to perform operations comprising:
receiving, from a client device associated with a user, a request to publish a video review of an item, the request including a description of the item, the description of the item including an identifier of the item;
accessing a user account associated with the user;
verifying that the user previously purchased the item_{;} the verifying including determining that the identifier of the item is associated with the user account; and
causing, based on the verifying that the user previously purchased the item, online publishing of the video review as a verified video review of the item in a feed of video reviews, the feed of video reviews including one or more verified video reviews, each of the video reviews being associated with a link to facilitate purchasing the item being reviewed in a particular video review.

18. The non-transitory machine-readable medium of claim 17, further comprising:
providing a reward to the user based on the causing of the online publishing of the video review as a verified video review based on the verifying that the user previously purchased the item.

19. The non-transitory machine-readable medium of claim 17, further comprising:
providing a reward to the user based on determining that another user purchased the item based on selecting the link included in the video review.

20. The non-transitory machine-readable medium of claim 17, wherein the causing online publication of the video review as a verified video review of the item in the feed of video reviews includes:
associating, based on the verifying that the user previously purchased the item, the item identifier with a verification tag in a database record, the verification tag indicating that the video review is verified; and
causing display, in a user interface of the client device, of a representation of the verification tag in association with the verified video review included in the feed of video reviews.
